(19) United States
(12) Patent Application Publication
(10) Pub. No.: US 2021/0317645 A1
(43) Pub. Date: Oct. 14, 2021

(54) Plumbing Trap Assembly

(71) Applicants: Louis Collins, Camarillo, CA (US); Yvonne Collins, Camarillo, CA (US)

(72) Inventors: Louis Collins, Camarillo, CA (US); Yvonne Collins, Camarillo, CA (US)

(21) Appl. No.: 16/844,065

(22) Filed: Apr. 9, 2020

(51) Int. Cl. E03C 1/122; F16L 47/16

(52) U.S. Cl. CPC E03C 1/122; F16L 47/16

(57) ABSTRACT

A plumbing trap assembly for integrating a plumbing trap into a variety of plumbing geometries includes a plumbing trap that has an inlet and an outlet for plumbing into an existing sewer system of a building. The plumbing trap is curved between the inlet and the outlet to trap water for inhibiting back flow of sewer gasses through the plumbing trap. The plumbing trap has a plurality of threaded sections thereon. The threaded sections are spaced apart from other thereby facilitating the plumbing trap to be cut between a selected pair of the threaded sections. In this way the plumbing trap has an adjustable length to facilitate the plumbing trap to be integrated into a variety of plumbing geometries.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to plumbing trap devices and more particularly pertains to a new plumbing trap device for integrating a plumbing trap into a variety of plumbing geometries.

### (2) Description of Related Art Including Information Disclosed Under 37 CFR 1.97 and 1.98

The prior art relates to plumbing trap devices. The prior art discloses a plumbing trap that has a slidably adjustable section. The prior art discloses a plumbing trap that has an adjustable diameter for accommodating a variety of plumbing geometries. Additionally, the prior art discloses a plumbing trap that includes a flexible section to enhance clearing blockages from the plumbing trap. The prior art discloses a plumbing trap that comprises a plurality of slidably adjustable sections. The prior art discloses a plumbing trap that has a plurality of flexible sections for integrating into a variety of plumbing geometries. The prior art also discloses a plumbing fixture that includes a hinged lock for quick disassembly.

### BRIEF SUMMARY OF THE INVENTION

An embodiment of the disclosure meets the needs presented above by generally comprising a plumbing trap that has an inlet and an outlet for plumbing into an existing sewer system of a building. The plumbing trap is curved between the inlet and the outlet to trap water for inhibiting back flow of sewer gasses through the plumbing trap. The plumbing trap has a plurality of threaded sections thereon. The threaded sections are spaced apart from other thereby facilitating the plumbing trap to be cut between a selected pair of the threaded sections. In this way the plumbing trap has an adjustable length to facilitate the plumbing trap to be integrated into a variety of plumbing geometries.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a plumbing trap assembly according to an embodiment of the disclosure.

FIG. 2 is a right side view of an embodiment of the disclosure.

FIG. 3 is a back view of an embodiment of the disclosure.

FIG. 4 is a right side view of an embodiment of the disclosure.

FIG. 5 is a perspective in-use view of an embodiment of the disclosure.

### DETAILED DESCRIPTION OF THE INVENTION

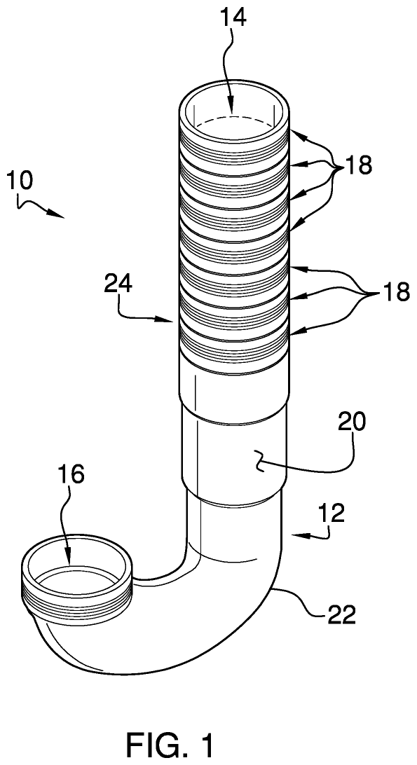

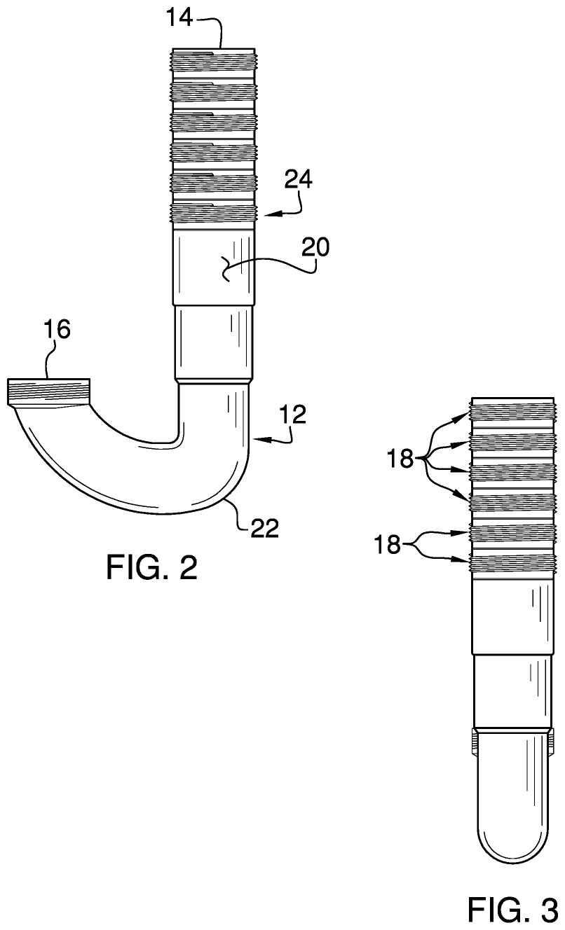

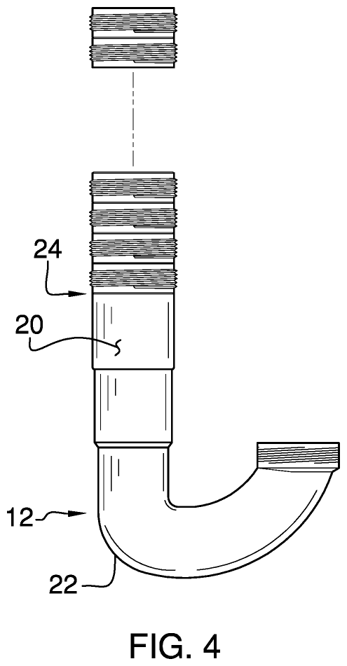

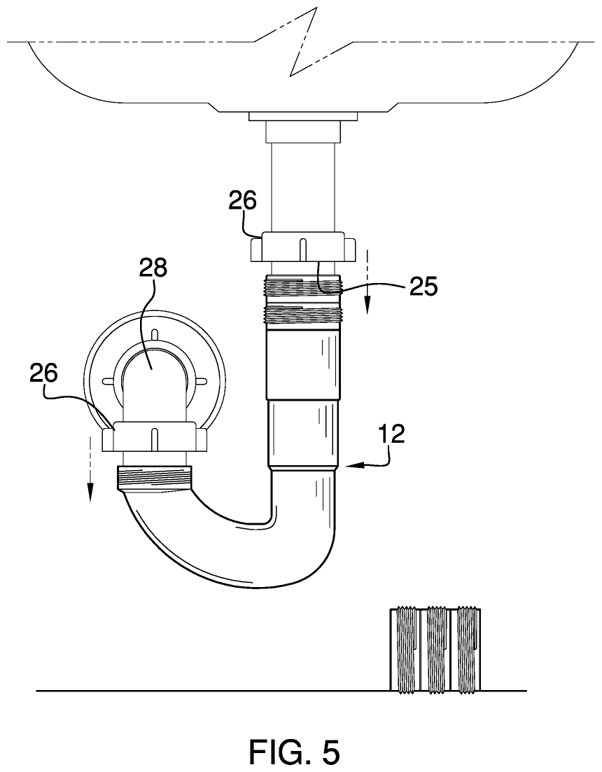

With reference now to the drawings, and in particular to FIGS. 1 through 5 thereof, a new plumbing trap device embodying the principles and concepts of an embodiment of the disclosure and generally designated by the reference numeral 10 will be described.

As best illustrated in FIGS. 1 through 5, the plumbing trap assembly 10 generally comprises a plumbing trap 12 that has an inlet 14 and an outlet 16, and the plumbing trap 12 can be plumbed into an existing sewer system of a building. The building may be a house, an apartment building, an office building or any other type of building that has a sewer system. The plumbing trap 12 is curved between the inlet 14 and the outlet 16 to trap water for inhibiting back flow of sewer gasses through the plumbing trap 12. Moreover, the plumbing trap 12 has a plurality of threaded sections 18 thereon and the threaded sections 18 are spaced apart from other. In this way the plumbing trap 12 can be cut between a selected pair of the threaded sections 18 thereby facilitating the plumbing trap 12 to have an adjustable length. Thus, the plumbing trap 12 can be integrated into a variety of plumbing geometries.

The plumbing trap 12 may be comprised of schedule 40 PVC pipe, with a variety of diameters, such that the plumbing trap 12 conforms to Uniform Plumbing Code. The plumbing trap 12 has an outer surface 20 extending between the inlet 14 and the outlet 16. Additionally, the plumbing trap 12 has a bend 22 positioned closer to the outlet 16 than the inlet 14 to define an elongated portion 24 of the plumbing trap 12 extending between the inlet 14 and the bend 22. The inlet 14 is spaced above the outlet 16 and each of the threaded sections 18 extends around a full circumference of the outer surface 20.

The threaded sections 18 are positioned on the elongated portion 24 of the plumbing trap 12. In this way a respective one of the threaded sections 18 can threadably engage a plumbing fitting for fluidly coupling the inlet 14 to a sink drain 25. The threaded sections 18 extend from the inlet 14 toward the bend 22. The outer surface 20 is threaded adjacent to the outlet 16 wherein the outlet 16 is configured to threadably engage a plumbing fitting 26 for fluidly coupling the outlet 16 to a sewer line 28.

In use, the plumbing trap 12 is positioned in a proposed installation location to identify the length to which the elongated portion 24 should be cut. The elongated portion 24 is cut between a respective pair of threaded sections 18 to trim the elongated portion 24 to the required length to match the existing plumbing geometry. In this way the plumbing trap 12 can be easily installed into a variety of plumbing geometries without requiring existing plumbing to be modified.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A plumbing trap assembly having a plurality of threaded sections to facilitate said assembly to have an adjustable length, said assembly comprising:
a plumbing trap having an inlet and an outlet wherein said plumbing trap is configured to be plumbed into an existing sewer system of a building, said plumbing trap being curved between said inlet and said outlet wherein said plumbing trap is configured to trap water for inhibiting back flow of sewer gasses through said plumbing trap, said plumbing trap having a plurality of threaded sections thereon, said threaded sections being spaced apart from other thereby facilitating said plumbing trap to be cut between a selected pair of said threaded sections thereby facilitating said plumbing trap to have an adjustable length wherein said plumbing trap is configured to be integrated into a variety of plumbing geometries.

2. The assembly according to claim 1, wherein said plumbing trap has an outer surface extending between said inlet and said outlet, said plumbing trap having a bend positioned closer to said outlet than said inlet to define an elongated portion of said plumbing trap extending between said inlet and said bend, said inlet being spaced above said outlet.

3. The assembly according to claim 2, wherein each of said threaded sections extends around a full circumference of said outer surface, said threaded sections being positioned on said elongated portion of said plumbing trap wherein a respective one of said threaded sections is configured to threadably engage a plumbing fitting for fluidly coupling said inlet to a sink drain.

4. The assembly according to claim 2, wherein said threaded sections extend from said inlet toward said bend.

5. The assembly according to claim 2, wherein said outer surface is threaded adjacent to said outlet wherein said outlet is configured to threadably engage a plumbing fitting for fluidly coupling said outlet to a sewer line.

6. A plumbing trap assembly having a plurality of threaded sections to facilitate said assembly to have an adjustable length, said assembly comprising:
a plumbing trap having an inlet and an outlet wherein said plumbing trap is configured to be plumbed into an existing sewer system of a building, said plumbing trap being curved between said inlet and said outlet wherein said plumbing trap is configured to trap water for inhibiting back flow of sewer gasses through said plumbing trap, said plumbing trap having a plurality of threaded sections thereon, said threaded sections being spaced apart from other thereby facilitating said plumbing trap to be cut between a selected pair of said threaded sections thereby facilitating said plumbing trap to have an adjustable length wherein said plumbing trap is configured to be integrated into a variety of plumbing geometries, said plumbing trap having an outer surface extending between said inlet and said outlet, said plumbing trap having a bend positioned closer to said outlet than said inlet to define an elongated portion of said plumbing trap extending between said inlet and said bend, said inlet being spaced above said outlet, each of said threaded sections extending around a full circumference of said outer surface, said threaded sections being positioned on said elongated portion of said plumbing trap wherein a respective one of said threaded sections is configured to threadably engage a plumbing fitting for fluidly coupling said inlet to a sink drain, said threaded sections extending from said inlet toward said bend, said outer surface being threaded adjacent to said outlet wherein said outlet is configured to threadably engage a plumbing fitting for fluidly coupling said outlet to a sewer line.
